(19) United States
(12) Patent Application Publication
(10) Pub. No.: US 2014/0040020 A1
(43) Pub. Date: Feb. 6, 2014

(54) MEASURING EFFECT OF IMPRESSIONS ON SOCIAL MEDIA NETWORKS

(71) Applicants: Santhosh Kumar Shanmugam, Milpitas, CA (US); Jarvis Cheng Yu Mak, Pleasanton, CA (US)

(72) Inventors: Santhosh Kumar Shanmugam, Milpitas, CA (US); Jarvis Cheng Yu Mak, Pleasanton, CA (US)

(73) Assignee: ROCKET FUEL, INC., Redwood City, CA (US)

(21) Appl. No.: 14/006,090

(22) PCT Filed: Jun. 27, 2012
(86) PCT No.: PCT/US2012/044349

§ 371 Date: Oct. 3, 2013

Related U.S. Application Data
(60) Provisional application No. 61/501,609, filed on Jun. 27, 2011.

(51) Int. Cl. G06Q 50/00; G06Q 30/02

(52) U.S. Cl. CPC G06Q 50/01; G06Q 30/0246
USPC 705/14.45

(57) ABSTRACT

The present invention generally relates to a marketing strategy to measure the impact of internet advertisements on users who utilize social media networks. The social media networks choose to release only a certain amount of data such as the number of visits to a particular webpage within the social media network, the number of users who like the particular webpage, etc. With an advertisement, it is hoped that the number of users who visit or like the particular webpage will increase. The effectiveness of the advertisement is measured based upon the actual increase in the number of users who visit or like the webpage compared to the expected increase in the number of users in absence of the advertisement. The expected increase in the number of users is calculated based upon historical trends for the webpage in question.

### BACKGROUND

1. Field of the Invention

Embodiments of the present invention generally relate to a computer-readable medium and a method performed by a computer-readable medium for measuring the effect of impressions on visits to webpages within social media networks.

2. Description of the Related Art

Social media networks, such as Facebook, Twitter, MySpace, YouTube, etc. are increasing in popularity. As of 2011, Facebook alone has more than 500 million active users with more than 50 percent of those users logging onto Facebook in any given day. To take advantage of the high usage of social media networks, entities with a product to sell want to utilize social media networks to increase their product's visibility awareness, and/or sales.

Conventional systems for advertising a product on the internet involve an ad or impression shown to a user. If the impression is effective, the user performs a particular action as a result of being shown the impression. An example of the particular action is clicking on the impression and being directed to a webpage within a social media network. However, there are users who would naturally perform the particular action regardless of whether the user has been exposed to the impression. Therefore, a truly effective impression is one that causes a user who would not otherwise perform the particular action to perform the particular action.

Typically, social media networks such as Facebook have internal control over the advertisements that are presented on webpages within the social media network. Therefore, media buyers (i.e., advertising agencies) tend to show impressions to users outside of the social media network with the hope of directing the user to a predetermined webpage within the social media network. To date, there is no effective manner to measure the effect of impressions used to direct users to predetermined webpages within social media networks.

Therefore, there is a need for a technique to measure the effectiveness of a campaign in directing a user to predetermined webpages within social media networks.

### SUMMARY

The present disclosure generally relates to a marketing strategy to measure the impact of internet advertisements on users who utilize social media networks. The social media networks provide an API (Application Programming Interface) for third parties to access certain data and statistics about the social media network, such as the number of visits to a particular webpage within the social media network, the number of users who “like” the particular webpage, the number of views of a particular video, etc. The goal of a particular marketing campaign may be to increase the number of users who visit or like a particular webpage. The effectiveness of the campaign is measured based upon the actual increase in the number of users who visit or like the webpage compared to the expected increase in the number of users in absence of the advertisement. The expected increase in the number of users is calculated based upon historical trends for the webpage in question.

In one embodiment, a method comprises tracking the number of users who ‘like’ a brand or become followers of the brand or watch a video on a predetermined webpage for the brand (i.e., click on a predetermined webpage) within a social media internet network for a first predetermined period of time, calculating a predicted number of users expected to ‘like’ the brand or become followers of the brand or watch the video on the predetermined webpage for the brand (i.e., click on the predetermined webpage) within the social media network for a second predetermined period of time, running an advertising campaign for the second predetermined period of time that encourages users who are outside of the social media network to ‘like’ the brand or become followers of the brand or watch the video on the predetermined webpage for the brand (i.e., visit the predetermined webpage) within the social media network, tracking the number of actual users who ‘like’ the brand or become followers of the brand or watch the video on the predetermined webpage for the brand (i.e., click on the predetermined webpage) within the social media network for the second predetermined period of time and comparing the number of actual users to predicted number of users to measure an impact of the advertising campaign.

In another embodiment, a computer-readable storage medium storing instructions capable of being executed by a processor, which, when executed, perform an operation is disclosed. The operation comprises tracking the number of users who ‘like’ a brand or become followers of the brand or watch a video on a predetermined webpage for the brand (i.e., click on a predetermined webpage) of a social media network for a first predetermined period of time, calculating a predicted number of users expected to ‘like’ the brand or become followers of the brand or watch the video on the predetermined webpage for the brand (i.e., click on the predetermined webpage) of the social media network for a second predetermined period of time, running an advertising campaign for the second predetermined period of time that encourages users who are outside of the social media network to ‘like’ the brand or become followers of the brand or watch the video on the predetermined webpage for the brand (i.e., visit the predetermined webpage) within the social media network, tracking the number of actual users who ‘like’ the brand or become followers of the brand or watch the video on the predetermined webpage for the brand (i.e., click on the predetermined webpage) within the social media network for the second predetermined period of time and comparing the number of actual users to predicted number of users to measure an impact of the advertising campaign.

In another embodiment, a system comprises a processor and a memory storing one or more application programs, which, when executed on the processor, are configured to perform an operation. The operation comprises tracking the number of users who ‘like’ a brand or become followers of the brand or watch a video on a predetermined webpage for the brand (i.e., click on a predetermined webpage) within a social media network for a first predetermined period of time, calculating a predicted number of users expected to ‘like’ the brand or become followers of the brand or watch the video on the predetermined webpage for the brand (i.e., click on the predetermined webpage) within the social media network for a second predetermined period of time, running an advertising campaign for the second predetermined period of time that encourages users who are outside of the social media network to ‘like’ the brand or become followers of the brand or watch the video on the predetermined webpage for the brand (i.e., visit the predetermined webpage) of the social media network, tracking the number of actual users who ‘like’ the brand or become followers of the brand or watch the video on the predetermined webpage for the brand (i.e., click on the predetermined webpage) of the social media network for the second predetermined period of time and comparing the number of actual users to predicted number of users to measure an impact of the advertising campaign.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only typical embodiments and are therefore not to be considered limiting.

FIG. 1 illustrates a computing system configured for delivering online advertising, according to one embodiment of the invention.

FIG. 2 is a more detailed view of an ad server of FIG. 1 within which embodiments of the invention may be implemented.

FIG. 3 illustrates an example of a computing system used to view online content, according to certain embodiments of the present disclosure.

FIG. 4 is a flow chart showing the method of obtaining a baseline model for predicting the number of users who will click to a predetermined webpage of a social media network, according to one embodiment of the disclosure.

FIG. 5 is a flow chart showing the method of running an advertising campaign and measuring the effectiveness of the advertising campaign on a social media network, according to one embodiment of the disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure generally relates to a marketing strategy to measure the impact of internet advertisements on users who utilize social media networks. The social media networks provide an API (Application Programming Interface) for third parties to access certain data and statistics about the social media network, such as the number of visits to a particular webpage within the social media network, the number of users who “like” the particular webpage, the number of views of a particular video, etc. The goal of a particular marketing campaign may be to increase the number of users who visit or like a particular webpage. The effectiveness of the campaign is measured based upon the actual increase in the number of users who visit or like the webpage compared to the expected increase in the number of users in absence of the advertisement. The expected increase in the number of users is calculated based upon historical trends for the webpage in question.

The data associated with most social media networks are stored privately by the social media network so that only the data that the social media network is willing to make publically available (e.g., through APIs) is usable by third parties. For example, when a user visits a regular webpage, such as Google.com or CNN.com, a cookie is stored in memory on the user's computer. The cookie includes data regarding the user's internet browsing history and/or computer. When the user views the webpage, one or more ads may appear on the webpage. An ad server can provide the ad to the webpage. For example, in the short amount of time (e.g., milliseconds) between when the user requested the webpage, i.e., from a web server, and when the webpage actually appears in the user's internet browser, the ad space on the webpage is offered for sale to a media buyer. A request from an ad server to place a bid on ad space on the webpage is sent to the media buyer. In that short amount of time, the media buyer decides whether to purchase the ad space for that particular webpage that is being viewed by the particular user.

In order to determine whether to show an ad or impression to the user, the media buyer examines the information in one or more cookies. The media buyer receives data regarding the internet browsing history and/or computer information and compares the received data of the user to historical data. The media buyer then decides whether to place a bid to deliver an advertisement. Thus, two different users, when accessing Google.com or CNN.com for example, may be shown different advertisements even though the content of the webpage (i.e., the information not including the advertisements) is identical. For social media networks, the cookies are not as useful to the media buyer because the social media network controls the advertising that occurs within the network.

In order to advertise on social media networks, companies can create their own webpage within the social media network. The webpage will be customized as the company sees fit. For example, the webpage may contain coupon codes, images designed to attract a particular audience's attention, notices of events pertaining to promotion of the product or company, etc. The webpage within the social media network is, in essence, an advertisement designed to increase sales and/or brand awareness for the product or company. While no direct sales are typically made through the webpage on the social media network, the goal of the webpage is to drive users to make a purchase in the future either at a store or on a webpage outside of the social media network.

Companies that maintain a webpage on social media networks such as Facebook aim to have users like the webpage by clicking the “Like” button on the company's Facebook webpage. Those users who like the webpage are considered “fans.” Over the course of time, there will be a number of users who will like the webpage, which is tracked by Facebook as a fan count. The fan count is publically available data, e.g., through Facebook's API. Over time, more fans accumulate and thus, the fan count increases. By tracking the fan count over time, the effects of seasonal fluxuations of the fan count may be determined as may the general trend of the fan count increase. An effective advertising campaign increases the number of users who like the webpage for a predetermined period of time over the number of users who would be expected to like the webpage in absence of the advertising campaign for the predetermined period of time.

Before the advertising campaign begins, a baseline for the particular product or company to be advertised is established. Continuing with the Facebook example, the baseline model is made by identifying the current level, trend, and seasonality of the fan count data using, for example, the Holt-Winters exponential smoothing method. The model helps predict the baseline fan count for periods in the future using local level, trend, and seasonality information that is estimated from an exponential model. The difference between the predicted and actual fan count is an effective approximation of the effect of the ads or impressions that are presented to users. The difference is verified using a least squares method to predict fan count using impressions and clicks as dependent variables. The fan count is measured over a first predetermined period of time along with other data, such as the time of the year, which may affect the fan count.

Once the baseline has been established and the predicted fan count increase is calculated, the advertising campaign may begin. The ads or impressions are shown to users on webpages outside of the social media network for a second predetermined period of time. The impressions contain hyperlinks to the webpage within the social media network. Once the second predetermined period of time is over, no more ads or impressions are shown to users as part of the campaign, and the fan count for the product or company is retrieved. The difference between the actual fan count and the predicted fan count shows the number of users who clicked the “Like” button in response to the ad or impression, also referred to as “lift.” By implementing the disclosed embodiments, the media buyer has a tangible technique to measure the effectiveness of its advertising campaign based upon the data that is publically available from the social media network.

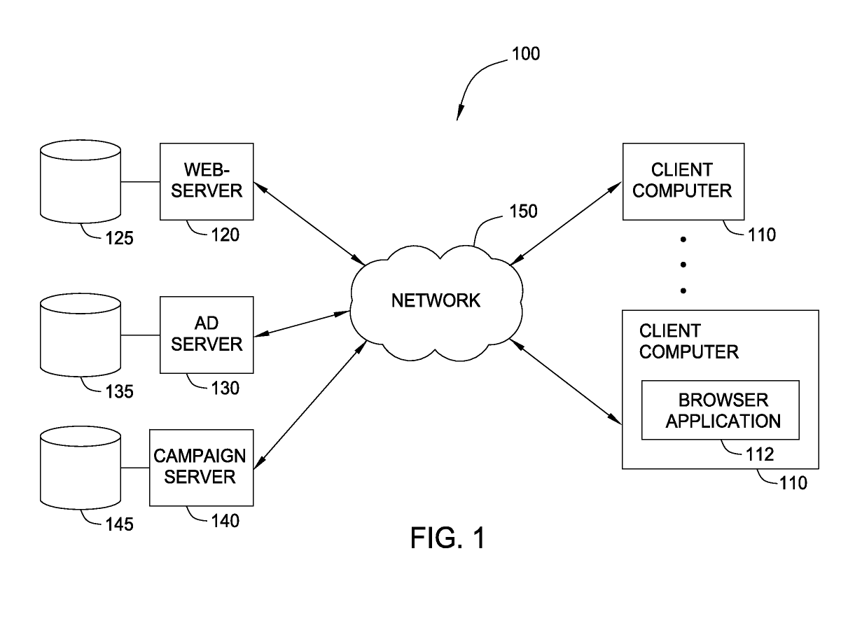

FIG. 1 illustrates a computing system 100 configured for delivering online advertising, according to one embodiment of the invention. As shown, the computing system 100 includes a web server 120, an ad server 130, a campaign server 140, and a plurality of client computers 110 (only two of which are shown for clarity), each connected to a communications network 150 (e.g., the Internet). For example, the web server 120 may be programmed to communicate with the client computers 110, the ad server 130, and the campaign server 140 using a networking protocol such as TCP/IP protocol.

Each client computer 110 may include conventional components of a computing device, e.g., a processor, system memory, a hard disk drive, input devices such as a mouse and a keyboard, and/or output devices, such as a monitor. The web server 120 includes a processor and a system memory (not shown), and may be configured to manage web pages and other media content stored in its respective content storage unit 125 using a file system and/or a relational database software. The ad server 130 is a specialized web server configured to manage advertising content stored in its respective content storage unit 135. The campaign server 140 is a server configured to manage an advertising campaign utilizing techniques described herein and is described in further detail below.

In the embodiments of the present invention described below, users are respectively operating the client computers 110 that may communicate over the network 150 to request web pages and other media content data from the web server 120. Each client computer 110 may be configured to execute a software application, such as a web browser application 112, and access web pages and/or media content data managed by the web server 120 by specifying a uniform resource locator (URL) for the web server 120 into the web browser application 112. The web pages that are displayed to a user are transmitted from the web server 120 to the user's client computer 110 and processed by the web browser application 112 for display through a monitor of the user's client computer 110.

In one embodiment, the web pages may contain an instruction, often referred to as an “ad tag,” to request advertising content from the ad server 130. In response to processing a web page having an ad tag, the web browser application 112 may be programmed to request advertising content from the ad server 130. The ad server 130 receives advertising requests from web browser applications 112 and retrieves and transmits ad content to the client computers 110. The web browser application 112 may receive the advertising content and display the advertising to the user through the monitor of the user's client computer 110. In one embodiment, the web browser application 112 may display the advertising inline and/or integrated with the requested web page content.

In one embodiment, the ad server 130 may communicate with the campaign server 140 to coordinate selection of ad content to serve to the client computers 110. The ad server 130 may provide to the campaign server 140 the identity of the requesting client computer 110, e.g., by transmitting one or more cookies associated with client computer 110 to the campaign server 140. The campaign server 140 administers an advertising campaign and selects ad content associated with the advertising campaign according to techniques described further below. In one embodiment, the campaign server 140 may direct the ad server 130 to serve particular ad content to the client computers 110 by signaling to the ad server 130 at least an advertisement identifier corresponding to the selected ad content.

According to various implementations, the client computer 110 may be a personal computer, laptop, mobile computing device, smart phone, video game console, home digital media player, network-connected television, set top box, and/or other computing devices having components suitable for communicating with the communications network 150. The client computer 110 may also execute other software applications configured to receive advertising content from the ad server 130, such as, advertising-supported software (“adware”), computer and video games, media players, and/or widget platforms.

Further, while the ad server 130 is depicted as a single entity in FIG. 1 for sake of discussion, it is understood that the ad server 130 represents an ad-delivering system that may be implemented using a variety of architectures and configurations having multiple components, modules, and/or servers in communication. The ad-delivering system may include ad-delivering servers, ad exchanges, demand side platforms (DSPs), ad networks (horizontal and vertical), analytic platforms, data management platforms, data aggregators, targeted and behavioral advertising platforms, and/or campaign management systems. Additionally, where the campaign server 140 is described herein as providing ad content to a user or customer, it is understood that the campaign server 140 may direct or instruct a third-party component or server, such as the ad server 130, to transmit ad content to the user or customer.

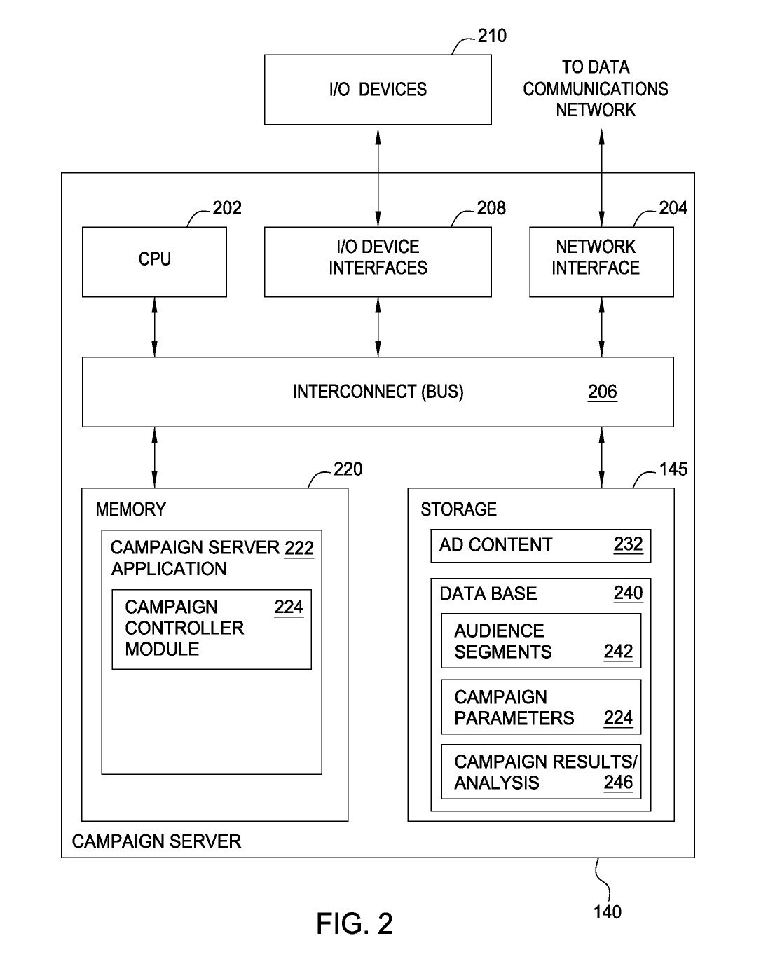

FIG. 2 is a more detailed view of the campaign server 140 of FIG. 1 within which embodiments of the invention may be implemented. As shown, the campaign server 140 includes, without limitation, a central processing unit (CPU) 202, a network interface 204, memory 220, and storage 145 communicating via an interconnect bus 206. The campaign server 140 may also include I/O device interfaces 208 connecting I/O devices 210 (e.g., keyboard, video, mouse, audio). The campaign server 140 may further include a network interface 204 configured to transmit data via the communications network 150.

The CPU 202 retrieves and executes programming instructions stored in the memory 220 and generally controls and coordinates operations of other system components. Similarly, the CPU 202 stores and retrieves application data residing in the memory 220. The CPU 202 is included to be representative of a single CPU, multiple CPUs, a single CPU having multiple processing cores, and the like. The interconnect bus 206 is used to transmit programming instructions and application data between the CPU 202, I/O devices interface 208, storage 145, network interface 204, and memory 220.

The memory 220 is generally included to be representative of a random access memory and, in operation, stores software applications and data for use by the CPU 202. Although shown as a single unit, the storage 145 may be a combination of fixed and/or removable storage devices, such as fixed disc drives, floppy disc drives, hard disk drives, flash memory storage drives, tape drives, removable memory cards, CD-ROM, DVD-ROM, Blu-ray, HD-DVD, optical storage, network attached storage (NAS), or a storage area-network (SAN) configured to store non-volatile data.

According to embodiments of the invention, the memory 220 stores instructions and logic for executing a campaign server application 222. The campaign server application 222 includes a campaign controller module 224. The storage 145 includes a database of ad content 232 configured to store data for administering advertising campaigns, such as ad metadata 240 (e.g., advertisement IDs), audience data 242 (e.g., audience segments), campaign parameters 244, and campaign results and analysis 246. In one embodiment, the database 232 comprises a relational database. In other embodiment, the database 232 is any type of storage device.

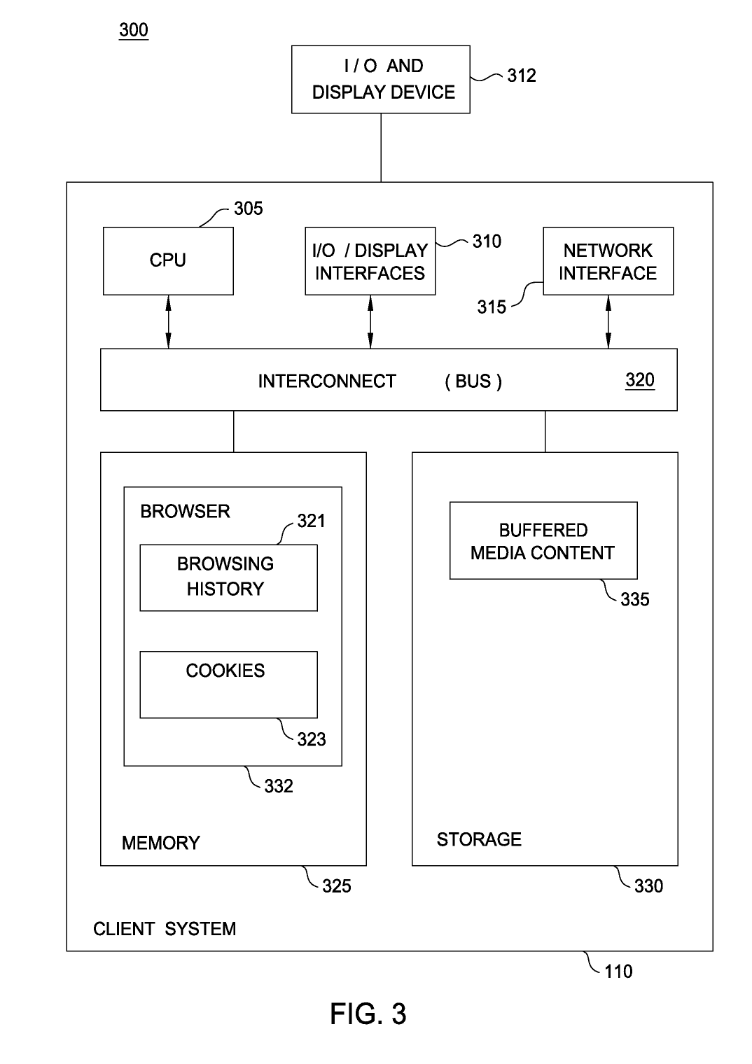

FIG. 3 illustrates an example of a client computing system 110 used to view online content, according to certain embodiments of the present disclosure. As shown, the client computing system 110 includes, without limitation, a central processing unit (CPU) 305, a network interface 315, an interconnect 320, a memory 325, and storage 330. The computing system 110 may also include an I/O devices interface 310 connecting I/O devices 312 (e.g., keyboard, display, and mouse devices) to the computing system 110.

Like CPU 202, CPU 305 is included to be representative of a single CPU, multiple CPUs, a single CPU having multiple processing cores, etc., and the memory 325 is generally included to be representative of a random access memory. The interconnect 320 is used to transmit programming instructions and application data between the CPU 305, I/O devices interface 310, storage 330, network interface 315, and memory 225. The network interface 315 is configured to transmit data via the communications network 150, e.g., to stream content from the web server 120, as well as to receive and present ads from the ad server 130. Storage 330, such as a hard disk drive or solid state (SSD) storage drive, may store non-volatile data. Illustratively, the memory 325 includes a web browser application 112, which itself includes a browsing history 321 and cookies 323, and the storage 330 stores buffered media content 335. The browser application 112 provides a software application which allows a user to access web pages and other content hosted by a server. In some embodiments, the browsing history 321 and/or the cookies 323 can be stored in memory 325 separately from the web browser application 112, or may be stored in storage 330.

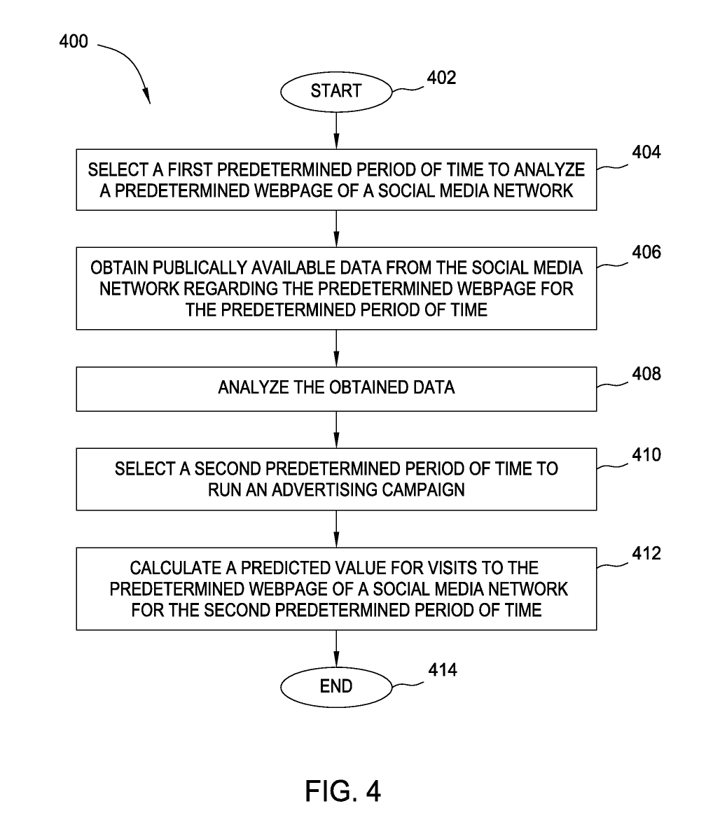

FIG. 4 is a flow chart 400 showing the method of obtaining a baseline model for predicting the number of users who will click to a predetermined webpage of a social media network, according to one embodiment of the present disclosure. The method starts at step 402 with the decision to run an advertising campaign for a particular product or company. A webpage, if not already established on the social media network, is created. Then, at step 404, a campaign server determines a first predetermined period of time to analyze a webpage of a social media network. The first predetermined period of time is the time period that is used to gather data for the baseline model. The first predetermined period of time should be sufficiently large to be able to obtain sufficient data to measure the number of users who visit or like the webpage. In one example, the first predetermined period of time may be as large as several months.

Once the first predetermined period of time is determined, at step 406, the campaign server obtains data from the social media network regarding the webpage for the first predetermined period of time. According to various embodiments, the data that is gathered can include the number or visitors to the webpage, the number of users who liked the webpage, the number of views of a video, the number of “followers” (i.e., Twitter followers), among others. The data is gathered in increments such as every 30 minutes over the first predetermined period of time.

At step 408, the campaign server analyzes the data to determine trends. For example, the trends may indicate when users visited the webpage or liked the webpage. Additional data may be considered, such as the particular day of the year or major events of the day that may have impacted the number of users who visited or liked the webpage. Based upon the analyzed data, the media buyer can determine a baseline model for the trends in users visiting or liking the webpage and is able to predict with reasonable certainty the number of users who would visit or like the website over a future period of time. Thus, at step 410, the campaign server determines a second predetermined period of time for running the advertising campaign, and at step 412, the campaign server calculates how many users should visit or like the webpage during the second predetermined period of time. The method terminates at step 414.

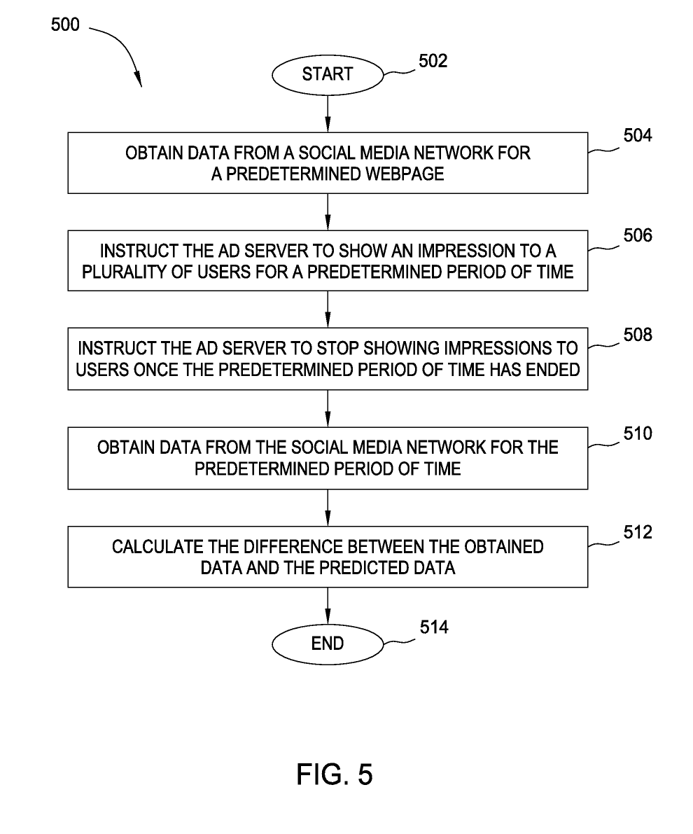

FIG. 5 is a flow chart 500 showing the method of running an advertising campaign and measuring the effectiveness of the advertising campaign on a social media network, according to one embodiment of the disclosure. The advertising campaign starts at step 502 after a baseline for visits to the webpage or liking of the webpage is established, i.e., using the technique of FIG. 4. At the outset of the advertising campaign, at step 504, the campaign server obtains data from the social media network in regards to the webpage for the zero time or beginning of the advertising campaign.

At step 506, the campaign server instructs the ad server to show impressions to a plurality of users for a predetermined period of time, i.e., runs the ad campaign. The ad campaign begins by instructing the ad server to show impressions or ads to a plurality of users who visit webpages outside of the social media network. The impressions are designed to induce the user to visit the predetermined webpage within the social media network and, in some cases, like the webpage within the social media network. Once the predetermined period of time has ended, at step 508, the campaign server obtains data from the social media network. Based upon the data received from the social media network, the media buyer now knows the actual number of users who either visited or liked the webpage within the social media network during the predetermined period of time. At step 510, the campaign server calculates the difference between the obtained data and the predicted data. For example, if the actual number of users who visited or liked the webpage is greater than the predicted number of users who would visit or like the webpage in absence of the impressions, then the impressions were effective.

Even though social media networks are closed networks in regards to media buyers, there is now an effective way to advertise outside of the social media network and measure the effectiveness of the impressions within the social media network. By targeting impressions to specific users over a predetermined period of time, the number of actual users who reacted favorably to the impression can be compared to the predicted number of users who would act favorably even in absence of the impression, and the effectiveness of the impressions is known. The campaign is designed such that the campaign is implemented in a burst-like fashion (i.e., impressions on some days and not on others); for example, impressions shown on two days a week and then rotating those days each week in order to account for day-of-week bias for the accumulation of fans.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

1. A method, comprising:
tracking the number of users who ‘like’ a brand or become followers of the brand or watch a video on a predetermined webpage for the brand of a social media network for a first predetermined period of time;
calculating a predicted number of users expected to ‘like’ the brand or become followers of the brand or watch the video on the predetermined webpage for the brand of the social media network for a second predetermined period of time;
running an advertising campaign for the second predetermined period of time that encourages users outside of the social media network to ‘like’ the brand or become followers of the brand or watch the video on the predetermined webpage for the brand of the social media network;
tracking the number of actual users who ‘like’ the brand or become followers of the brand or watch the video on the predetermined webpage for the brand of the social media network for the second predetermined period of time; and
comparing the number of actual users to predicted number of users to measure an impact of the advertising campaign.

2. The method of claim 1, wherein tracking the number of users who ‘like’ the brand or become followers of the brand or watch the video on the predetermined webpage for the brand of the social media network for a first predetermined period of time comprises:
calculating a baseline curve representing the number of users who actually ‘like’ the brand or become followers of the brand or watch the video on the predetermined webpage for the brand within a first predetermined period of time; and
calculating a predicted number of users to ‘like’ the brand or become followers of the brand or watch the video on the predetermined webpage for the brand for a second predetermined period of time.

3. The method of claim 2, wherein running an advertising campaign further comprises:
retrieving data regarding an internet browsing history of a user;
receiving a request from an ad server to place a bid on ad space for a webpage that the user will be visiting;
comparing the retrieved data of the user to historical data; and
placing a bid to deliver an advertisement.

4. The method of claim 3, wherein the advertisement is displayed on a webpage that is outside of the social media internet webpage.

5. The method of claim 4, wherein the advertisement includes a hyperlink to the predetermined webpage of the social media network.

6. The method of claim 1, wherein running an advertising campaign further comprises:
retrieving data regarding an internet browsing history of a user;
receiving a request from an ad server to place a bid on ad space for a webpage that the user will be visiting;
comparing the retrieved data of the user to historical data; and
placing a bid to deliver an advertisement.

7. The method of claim 6, wherein the advertisement is displayed on a webpage that is outside of the social media network and wherein the advertisement includes a hyperlink to the predetermined webpage within the social media network.

8. A computer-readable storage medium storing instructions capable of being executed by a processor, which, when executed, perform an operation, comprising:
tracking the number of users who ‘like’ a brand or become followers of the brand or watch a video on a predetermined webpage for the brand of a social media network for a first predetermined period of time;
calculating a predicted number of users expected to ‘like’ the brand or become followers of the brand or watch the video on the predetermined webpage for the brand of the social media network for a second predetermined period of time;
running an advertising campaign for the second predetermined period of time that encourages users to ‘like’ the brand or become followers of the brand or watch the video on the predetermined webpage for the brand of the social media network;
tracking the number of actual users who ‘like’ the brand or become followers of the brand or watch the video on the predetermined webpage for the brand of the social media network for the second predetermined period of time; and
comparing the number of actual users to predicted number of users to measure an impact of the advertising campaign.

9. The computer-readable storage medium of claim 8, wherein tracking the number of users who ‘like’ the brand or become followers of the brand or watch the video on the predetermined webpage for the brand of the social media network for a first predetermined period of time comprises:
calculating a baseline curve representing the number of users who actually ‘like’ the brand or become followers of the brand or watch the video on the predetermined webpage for the brand within a first predetermined period of time; and
calculating a predicted number of users to ‘like’ the brand or become followers of the brand or watch the video on the predetermined webpage for the brand for a second predetermined period of time.

10. The computer-readable storage medium of claim 9, wherein running an advertising campaign further comprises:
retrieving data regarding an internet browsing history of a user;
receiving a request from an ad server to place a bid on ad space for a webpage that the user will be visiting;
comparing the retrieved data of the user to historical data; and
placing a bid to deliver an advertisement.

11. The computer-readable storage medium of claim 10, wherein the advertisement is displayed on a webpage that is outside of the social media network.

12. The computer-readable storage medium of claim 11, wherein the advertisement includes a hyperlink to the predetermined webpage of the social media network.

13. The computer-readable storage medium of claim 8, wherein running an advertising campaign further comprises:
retrieving data regarding an internet browsing history of a user;
receiving a request from an ad server to place a bid on ad space for a webpage that the user will be visiting;
comparing the retrieved data of the user to historical data; and
placing a bid to deliver an advertisement.

14. The computer-readable storage medium of claim 13, wherein the advertisement is displayed on a webpage that is outside of the social media network and wherein the advertisement includes a hyperlink to the predetermined webpage of the social media network.

15. A system, comprising:
a processor; and
a memory storing one or more application programs, which, when executed on the processor, are configured to perform an operation, comprising:
tracking the number of users who ‘like’ a brand or become followers of the brand or watch a video on a predetermined webpage for the brand of a social media network for a first predetermined period of time;
calculating a predicted number of users expected to ‘like’ the brand or become followers of the brand or watch the video on the predetermined webpage for the brand of the social media network for a second predetermined period of time;
running an advertising campaign for the second predetermined period of time that encourages users outside of the social media network to ‘like’ the brand or become followers of the brand or watch the video on the predetermined webpage for the brand of the social media network;
tracking the number of actual users who ‘like’ the brand or become followers of the brand or watch the video on the predetermined webpage for the brand of the social media network for the second predetermined period of time; and
comparing the number of actual users to predicted number of users to measure an impact of the advertising campaign.

16. The system of claim 15, wherein tracking the number of users who click on the predetermined webpage of the social media network for a first predetermined period of time comprises:
calculating a baseline curve representing the number of users who actually ‘like’ the brand or become followers of the brand or watch the video on the predetermined webpage for the brand within a first predetermined period of time; and
calculating a predicted number of users to ‘like’ the brand or become followers of the brand or watch the video on the predetermined webpage for the brand for a second predetermined period of time.

17. The system of claim 16, wherein running an advertising campaign further comprises:
retrieving data regarding an internet browsing history of a user;
receiving a request from an ad server to place a bid on ad space for a webpage that the user will be visiting;
comparing the retrieved data of the user to historical data; and
placing a bid to deliver an advertisement.

18. The system of claim 17, wherein the advertisement is displayed on a webpage that is outside of the social media network.

19. The system of claim 18, wherein the advertisement includes a hyperlink to the predetermined webpage of the social media network.

20. The system of claim 15, wherein running an advertising campaign further comprises:
retrieving data regarding an internet browsing history of a user;
receiving a request from an ad server to place a bid on ad space for a webpage that the user will be visiting;
comparing the retrieved data of the user to historical data; and
placing a bid to deliver an advertisement, wherein the advertisement is displayed on a webpage that is outside of the social media internet webpage and wherein the advertisement includes a hyperlink to the predetermined webpage of the social media network.
